(19) United States
(12) Patent Application Publication
(10) Pub. No.: US 2017/0147887 A1
(43) Pub. Date: May 25, 2017

(54) METHOD AND APPARATUS FOR INTERIOR/EXTERIOR VEHICULAR ENVIRONMENT ALERTS

(71) Applicant: FORD GLOBAL TECHNOLOGIES, LLC, Dearborn, MI (US)

(72) Inventors: Tuan Anh BE, Livonia, MI (US); Noorulla MOHAMMED, Farmington Hills, MI (US); Nicholas COLELLA, Grosse Ile, MI (US); Allen R. MURRAY, Lake Orion, MI (US)

(21) Appl. No.: 14/949,297

(22) Filed: Nov. 23, 2015

(51) Int. Cl. G06K 9/00; B60Q 9/00; B60R 1/00

(52) U.S. Cl. CPC G06K 9/00791; B60R 1/00; B60Q 9/002

(57) ABSTRACT

A system includes a processor configured to display one or more vehicle camera images viewed by one or more vehicle cameras, on a vehicle display in response to a configuration request. The processor is also configured to capture one or more images upon user selection and store the images and corresponding user selected vehicle state data designating when the captured images should be used for an alert comparison. The same or a similar system can also utilize vehicle sensors in the same or similar manners.

### TECHNICAL FIELD

The illustrative embodiments generally relate to a method and apparatus for interior/exterior vehicular environment alerts.

### BACKGROUND

While vehicle owners attempt to take reasonable precautions to responsibly and safely use their vehicles, distracted owners may accidentally back a vehicle into a garage door, park near a fire-hydrant, park in a handicapped space or perform a similar maneuver where a review of the vehicular exterior environment would have immediately made the impropriety of the situation apparent.

### SUMMARY

In a first illustrative embodiment, a system includes a processor configured to issue an alert to a user mobile device upon a determination that image data, captured in response to a vehicle-related state condition associated with the alert, correlates to stored image data designated to represent an alert condition.

In a second illustrative embodiment, a system includes a processor configured to issue an alert to a user mobile device upon a determination that sensor data parameters, captured in response to a vehicle-related state condition associated with the alert, correlate to stored sensor data parameters designated to represent an alert condition.

In a third illustrative embodiment, a system includes a processor configured to display one or more vehicle camera images viewed by one or more vehicle cameras, on a vehicle-display, in response to a configuration request. The processor is also configured to capture one or more images upon user selection and store the images and corresponding user selected vehicle state data, designating when the captured images should be used for an alert-comparison.

### BRIEF DESCRIPTION OF THE DRAWINGS

FIG. 1 shows an illustrative vehicle computing system;

FIG. 2 shows an illustrative example of a notification configuration process;

FIG. 3 shows an illustrative example of a safety notification process;

FIG. 4 shows an illustrative example of a notification process; and

FIG. 5 shows a further illustrative notification process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

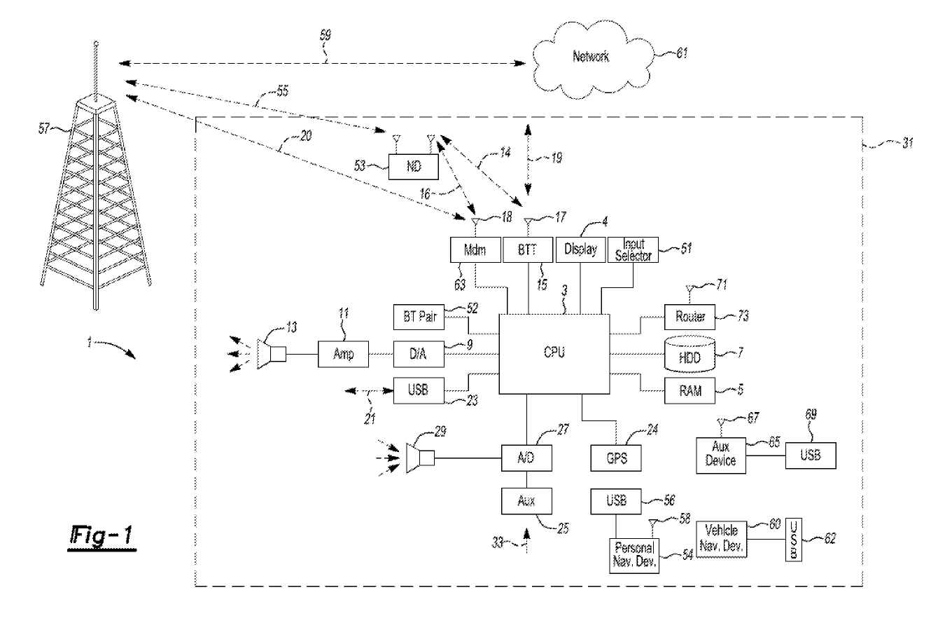

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

Through the use of vehicle sensors and cameras, the illustrative embodiments propose systems and methods for informing a vehicle owner of various vehicular environmental conditions. Some of these conditions may be pre-defined by an original equipment manufacturer (OEM), for example, the presence of a handicapped space in which the vehicle is parked, or the proximity to a fire hydrant, marked curb, or other no-parking indicia.

Other conditions may be user-defined. For example, a user could take a picture (using a rear camera) of a closed garage door, and then, some period of time after an ignition cycle ends and the vehicle is in a home-location (known by, for example, GPS coordinates), the vehicle read camera could compare the saved picture to what it is presently viewing, to determine if the garage door is closed behind the vehicle. If not, the vehicle could issue an alert to the driver that they left their garage door open. Other user-defined conditions can also be set in a similar manner, by uploading pictures of what a vehicle should or should not “see” and setting any corresponding vehicle-state considerations (e.g., in the garage door example, the vehicle should be at a home location and in an ignition off state). For example, at 2 AM, each night, the vehicle camera(s) could look for images of another vehicle and a bicycle, and if either were not presently viewable by at least one of the cameras, an alert could be issued to an owner that the bike or other vehicle did not appear to be present (e.g., that they might have been stolen).

Similarly, vehicle cameras and sensors can be used to alert an owner of any irregular movement in or around an unoccupied vehicle. In still another example, an interior camera can be used to identify an object within the vehicle (e.g., the user wants to ensure a laptop bag is present in the vehicle before leaving for work), and notify the owner if the object is missing from the vehicle. In such a case, the states of “leaving from home” and “between the hours of 7 AM and 8 AM” may be one condition required for making the laptop bag presence determination, and “leaving from work” (regardless of the hours) may be another condition required for another laptop bag presence determination. Thus, if the appropriate states are met, the vehicle cameras/sensors can check for the appropriate conditions and issue alerts to owners if a given condition does not appear to be met (or a condition that should not be met, is met, such as parking in a no-parking zone).

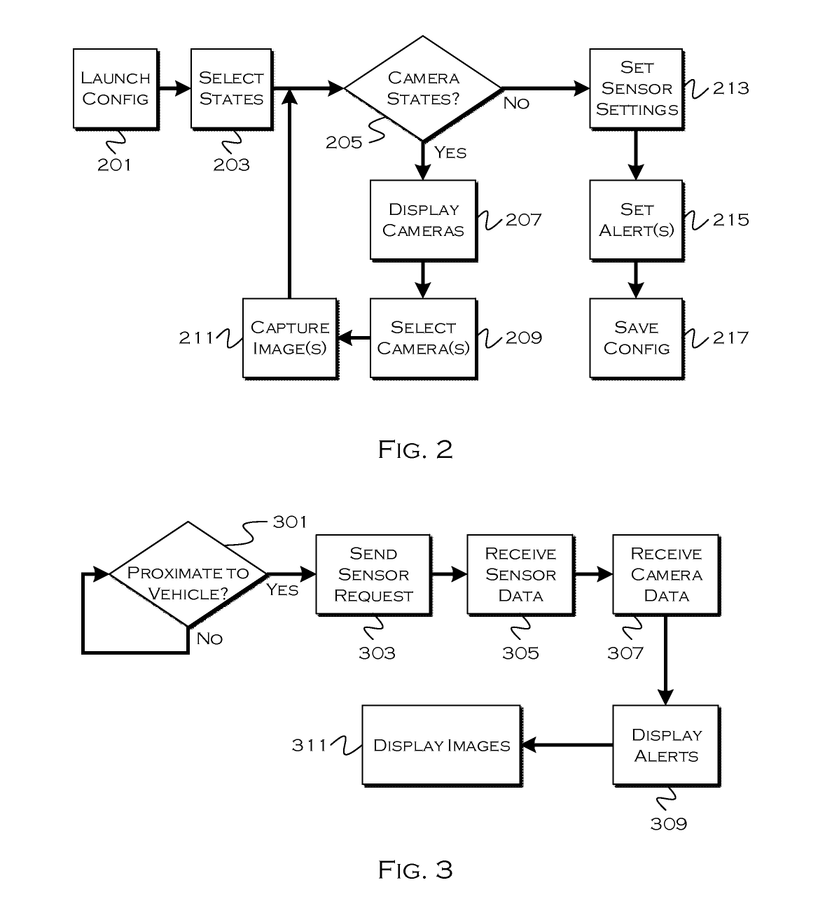

FIG. 2 shows an illustrative example of a notification configuration process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative embodiment, the user will configure one or more conditions to be observed by the vehicle cameras (interior and/or exterior) based on the uploading or capture of images from the cameras at the time of configuration. For example, if no conditions were manufacturer preset, and the user wanted to be informed if a fire hydrant was visible from any of the vehicle cameras, the user could upload a picture of a hydrant to correspond to a check performed when a vehicle is placed in a park state, or the user could drive to a fire hydrant and use a vehicle camera to take a picture of the hydrant.

In this example, the user first launches a configuration process 201. This could be done using an in-vehicle display, for example, so the user could see what the vehicle camera(s) see, using a center console display. In another example, a user could orient a known camera to be pointing towards a desired object, and could take a picture even if the user couldn't visually observe what the vehicle camera was photographing (for example, if the user wanted to photograph a closed garage door, the user could simply close the door and select a rear camera, safely assuming that given the size of the closed door, the rear camera would almost certainly take an image of the door).

After launching the process, the user can set one or more states that are to be associated with a particular camera/sensor check 203. For example, the user may only want to check for the presence of a large object (and/or the image of a garage door) when the vehicle is in a parked state and in a home location state. Other states may be set corresponding to other checks to be performed as well. For example, the user may only check for the presence of another vehicle in the garage after the vehicle reaches a 2 AM time state. Any reasonable state to control when the checks are performed may be set if desired.

If there are any camera states 205, the process can display, on a vehicle display, for example, the various camera views viewable by the current set of vehicle cameras 207. This allows for a user to select one or more cameras 209 and capture the images viewed by these cameras 211. This will associate these particular images with the given state, so that, for example, if the same object shown in the image is present, the process will recognize that as a trigger for an alert. Examples include, but are not limited to, fire hydrants, garage doors, other vehicles, etc.

Once all the camera states, if any, are handled, the process will allow the user to configure the particular sensor settings to be associated with alerts 213. This could include, for example, but is not limited to, a rain sensor, proximity sensors, etc. The particular alerts to be associated with the various sensor settings could also then be set 215. Finally, the configuration can be saved 217.

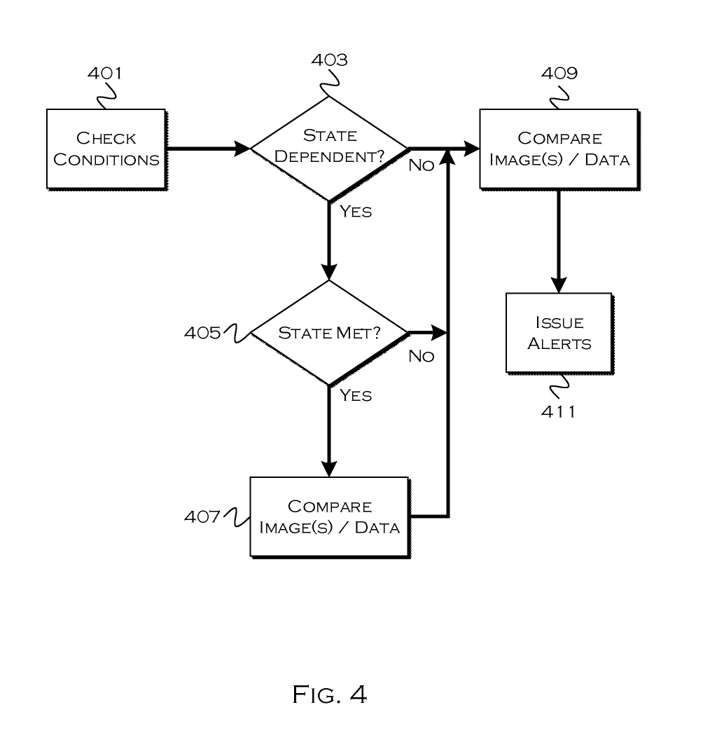

FIG. 3 shows an illustrative example of a safety notification process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process determines if a user is proximate to a vehicle 301. This is so that any alerts about suspicious conditions inside or outside the vehicle can be conveyed to the user as the user approaches the vehicle. Cameras and sensors can detect, for example, movement inside and outside the vehicle. But, for example, if a user is parked in a mall parking lot, there may be significant movement outside the vehicle, and the user isn't going to want an alert every time someone parks a car next to their vehicle and/or enters and exits a proximate vehicle.

On the other hand, the “proximate user” condition/state may be tied to an exterior sensor/camera check, but the interior sensors/cameras may be tied to a “user leaves proximity” state. In this manner, any time the user is not in the vehicle, the sensors and cameras inside the vehicle will alert the user to any movement once the user has walked away from the vehicle, since there should presumably be no movement inside the vehicle while the user is not present. This can be secondarily useful to determine, for example, if a child was left inside the vehicle.

In this example, once the user has approached within a predetermined distance to the vehicle (considered as “proximate”), the process will send a request to the vehicle sensors and/or cameras 303. For example, the process could run on a vehicle computer, and when a fob presence is detected (through passive transmission or through activation of a vehicle lock), the cameras/sensors could be engaged.

The process will receive data from the sensors 305 and/or cameras 307 and analyze the data to see if any conditions corresponding to a suspicious condition are met. For example, if proximity sensors at any portion of the vehicle detect an object within 1 foot of the vehicle, then there is likely either a person standing there, or a vehicle is parked very closely. Also, at the time of parking, the sensors could detect any static objects proximate to the vehicle, so that those objects are not considered in the sensor check, if desired. That is, only if there is a variance in some object close to the vehicle at the time of approach, is the sensor based alert triggered.

Also, the camera images can be received. These can be compared to generalized images of people crouching or standing near the vehicle (to determine if a proximate object is a person as opposed to a bush or a vehicle) and can also be compared to baseline images taken when the vehicle is parked, for example. Comparison to a baseline image could help identify, for example, a person-sized lump crouched between the vehicle and a wall, the image of the wall alone having been captured when the vehicle was first parked.

Received images that contain suspicious portions can result in the generation of camera alerts, or they can be broadcast to a receiving device (such as a smartphone) with a display, so the user can review the images to see if there is an actual concern. Any alerts generated from any alert-conditions being met can also be sent to the user 309, and the images can be displayed in conjunction with the alerts on a user device 311.

FIG. 4 shows an illustrative example of a notification process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In the illustrative example shown in FIG. 4, the process will issue general alerts or notifications based on some pre-set condition being detected by a camera or sensor. This is useful as a backup check, for example, to ensure the user is not improperly parked, or that any other number of objects are or are not present. For example, as previously noted, an image of a fire hydrant can be loaded into a memory. The cameras on the vehicle can check the surroundings for fire hydrants, which can be determined by an image comparison program. Since fire hydrants tend to be fixed in size, the viewed size of the fire hydrant can be used to determine how far the vehicle is from the hydrant, and a user can be alerted if the vehicle is within an impermissible distance of the hydrant (the distance possibly being user-configured based on local laws). For example, if all fire hydrants are 2.5 feet tall, and a viewed image of a hydrant from a particular camera at a distance of 5 feet results in a hydrant of a certain height in the image (since the camera can be set at a fixed zoom) moving the hydrant closer or further (or moving the vehicle) should scale the hydrant in some discernable fashion. So the vehicle may “know” that hydrants of M size in an image from a particular camera are X feet away, and hydrants of N size are Y feet away, and therefore a hydrant of O size will be Z feet from the camera. Based on the camera position on the vehicle, a distance to the hydrant can also be obtained.

Also, in the particular instance of a hydrant, for example, the system could actually photograph the hydrant if detected and if the user is outside a regulatory zone, in case the user is ticketed the picture may be useful to prove that the user wasn't actually parked to close to the hydrant.

In this illustrative example, the process first checks the conditions which a vehicle is set to detect 401. This can include, for example, “check for hydrant,” “check for closed garage door,” “check for handicapped space,” “check for motion outside the vehicle,” “check for motion inside the vehicle,” “check for presence of second vehicle,” to use the non-limiting examples previously presented as detectable conditions.

In this example, each of the exemplary “checks” has a particular set of states associated therewith, to prevent a great deal of unnecessary checking being performed at all times by the sensors and/or cameras (i.e., it probably doesn't make a lot of sense to check for a fire hydrant when a vehicle is traveling at 70 miles per hour on the highway). So, in this example, the following checks have the following states (shown in < >)associated therewith:

Check for hydrant→<parked>

Check for closed garage door→<parked, home location>

Check for handicapped space→<parked>

Check for motion outside the vehicle→<parked, user approaching>

Check for motion inside the vehicle→<parked, user left proximity>

Check for presence of second vehicle→<parked, home location, 2 AM-6 AM>

In these examples, if the state conditions are present 403, the process will then check if the state conditions are met 405. For example, whenever the vehicle is parked, the process will check for a hydrant and a handicapped space. In another example, the user may set some sort of <away from home> state if the check for hydrants/handicapped spaces is irrelevant at home.

If the state conditions are met 405, the process checks for the conditions corresponding to the state conditions. In this example, that check involves capturing and comparing image(s) and/or sensor data 407 to a stored set of image(s) and/or sensor readings. Additionally or alternatively, ranges for certain sensor readings could be stored, or other metrics to which the sensors or images could be compared. For example, instead of comparing an image to an image that is stored, characteristics of the captured image may be analyzed for suspicious or defined condition matching (e.g., if a sensor detects a proximate object, take an image of the object, if the image is primarily green, it is probably a bush, so disregard the object—this may be an oversimplification, but it represents an example of how an image characteristic can be used in analysis).

Also, in this example, there may be one or more conditions that is checked regardless of state. For example, a sensor provided below a vehicle may periodically check if anything is dragging below the vehicle or dangling from the undercarriage, regardless of vehicle state. Other sensor conditions or image conditions may also exist that are checked regardless of state, and the sensor and image data for those may also be compared against defined parameters 409.

Once all sensor data has been compared against the parameters, any alerts resulting from the comparison may be issued 411. These can include the actual readings of the sensors, the results of the comparisons (e.g., the reading vs. what was expected), and any images captured by the camera(s) for comparison purposes. In still another example, the system may be set to capture one or more images at certain times of the day, locations, etc. That is, without performing an explicit comparison, the system may have a trigger state that results in capture of a particular image and transmission of the image(s) captured.

Other examples of uses of sensor data include, for example, alerting a user when a vehicle is parked and there is insufficient room to fully open a vehicle door (based on proximity of an object to the vehicle door. Or, for example, if a vehicle is in drive and there is a low object in front of the vehicle (such as a parking lot barrier or curb) that the driver cannot see. These examples and the like can help avoid inadvertent damage to the vehicle. Images of items and objects left in a vehicle can also be considered. Also, pictures of accidents could be taken, pictures of other vehicles following to closely could be automatically taken to prove that the driver was not at fault in a rear-end collision, and pictures of drivers and passengers can ensure that only permitted occupants are in a vehicle. These are just a few non-limiting examples of uses for the illustrative embodiments.

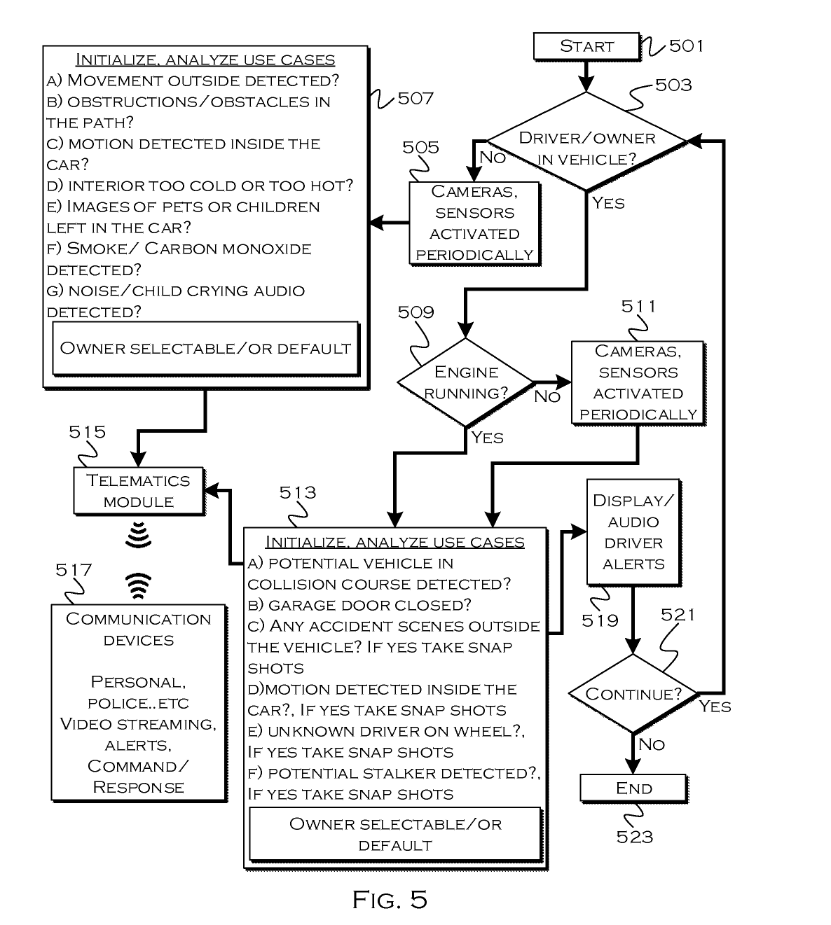

FIG. 5 shows a further illustrative notification process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process begins 501 at some time period. This process can engage periodically, when a vehicle is turned on, when a vehicle is turned off, etc. It can also wake-up and activate even if a vehicle is not active, if there are checks to be made while a driver is not in a vehicle.

Here, the process checks to see if the driver or other noted occupant is in the vehicle 503. In this example, certain checks can occur if the driver is in the vehicle (or if another registered and/or recognizable occupant is in the vehicle). If the driver is in the vehicle, the process also checks to see if the engine is currently running 509. If the engine is running, exemplary use cases (some, all or none of which are possibly engaged) are shown. Here, the exemplary, non-limiting checks include, for example:

Was there a collision? If so, pictures may be automatically snapped from vehicle cameras.

Is a garage door closed? This can be determined by, for example, a front-facing picture or rear facing picture as a vehicle leaves a home-location, the presence of a closed garage door can be determined based on a reference photo. Or, if the vehicle is still in the garage, a rear photo can be taken to ensure the driver does not back into the door.

Are there accident scenes (recognizable through reference images) outside the vehicle? If so, take pictures with vehicle cameras.

Is there motion in the vehicle (other than the driver or registered occupant(s))? If so, take pictures and alert driver.

Is there an unknown driver? This could result from a “yes” to the driver detection, but when no identification of the driver can be made. If yes, take pictures.

Is there a potential stalker outside the vehicle? This can be determined by comparing images from the cameras to reference photos or data, and sensor data can also be used in this manner, for this and other use cases. If yes, take pictures with vehicle cameras, show the pictures to the driver to alert the driver.

The telematics module 515 can then be engaged by the system if any emergency services (for stalkers, accidents, etc.) need to be alerted or other remote sources 517 need to be contacted. Also, any alerts can be displayed to the driver 519. The same processes can occur periodically 511 if a driver is present and the engine is not running. Once any alerts are displayed, the process can continue 521 or end 523.

If the driver or occupant is not present, the system can still engage the cameras and sensors periodically 505 to check for other conditions 507. These include, but are not limited to, outside movement around the vehicle (which could be a malicious party or could be innocuous other drivers), motion inside the vehicle (which could be used to detect a child or pet left behind in the vehicle), interior of the vehicle too hot or cold (which can cause HVAC engagement; this includes the vehicle being too hot or cold for beings or objects recognized as being left in the vehicle), images of pets or children left in the vehicle can also be detected, as well as smoke, carbon monoxide and even noise inside the vehicle. These tests can be used to send alerts to emergency services and/or owners as appropriate. Items like the temperature monitoring could even be dependent on whether or not certain objects were left in a vehicle. For example, it may be perfectly fine to allow a vehicle to rise to 110 degrees Fahrenheit in the middle of a day, when the user will not be in the vehicle for hours, but not so the case if, for example, an electronic device is left in the vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
issue an alert to a user mobile device upon a determination that image data, captured in response to a vehicle-related state condition associated with the alert, correlates to stored image data designated to represent an alert condition.

2. The system of claim 1, wherein the stored image data includes data designating a spot in which a user should not park.

3. The system of claim 2, wherein the stored image data includes a fire hydrant.

4. The system of claim 2, wherein the stored image data includes handicapped parking indicia.

5. The system of claim 1, wherein the state condition includes a parked state.

6. The system of claim 1, wherein the state condition includes a location.

7. The system of claim 1, wherein the state condition includes a time of day.

8. The system of claim 1, wherein the state condition includes a user proximity-to-the-vehicle state.

9. The system of claim 1, wherein the stored image data includes object parameters to be compared to an object in the captured image data.

10. The system of claim 9, wherein the object parameters are usable by the processor to determine a distance to the object based on a known object size.

11. The system of claim 9, wherein the object parameters include parameters representing humans in various states of posture, and the determination includes comparing the object in the captured image data to the parameters representing humans to determine if a human is proximate to the vehicle.

12. A system comprising:
a processor configured to:
issue an alert to a user mobile device upon a determination that sensor data parameters, captured in response to a vehicle-related state condition associated with the alert, correlate to stored sensor data parameters designated to represent an alert condition.

13. The system of claim 12, wherein the state condition includes a parked condition.

14. The system of claim 12, wherein the stored sensor data parameters include a distance-to-object parameter.

15. The system of claim 12, wherein the stored sensor data parameters include a distance needed to open a vehicle door, and the determination includes comparing captured distance to objects proximate to the vehicle door to the distance needed to open the door.

16. The system of claim 12, wherein the state condition includes a vehicle location.

17. The system of claim 12, wherein the state condition includes a user proximity-to-the-vehicle state.

18. The system of claim 12, wherein the sensor data parameters include parameters defining motion within a predefined distance of a vehicle exterior.

19. The system of claim 12, wherein the state condition includes a time of day.

20. A system comprising:
a processor configured to:
display one or more vehicle camera images viewed by one or more vehicle cameras, on a vehicle display in response to a configuration request;
capture one or more images upon user selection; and
store the images and corresponding user selected vehicle state data designating when the captured images should be used for an alert comparison.
